(19) United States
(12) Patent Application Publication
(10) Pub. No.: US 2015/0156286 A1
(43) Pub. Date: Jun. 4, 2015

(54) MESSAGE TUNNELING IN AN INDUSTRIAL NETWORK

(71) Applicant: Richard Blair, Plaistow, NH (US)

(72) Inventor: Richard Blair, Plaistow, NH (US)

(73) Assignee: SCHNEIDER ELECTRIC INDUSTRIES SAS, Rueil Malmaison (FR)

(21) Appl. No.: 14/406,080

(22) PCT Filed: Jun. 7, 2012
(86) PCT No.: PCT/US2012/041330

§ 371 Date: Dec. 5, 2014

(51) Int. Cl. H04L 29/06; H04L 29/08

(52) U.S. Cl. CPC H04L 69/18; H04L 67/02

(57) ABSTRACT

A networking system is discussed. The system may be used for industrial networks where access to field device data is valuable. Commands, such as read or write requests to particular field device data, may be encapsulated within application layer protocol messages, such as MODBUS messages. Responses to the commands may also be encapsulated within MODBUS messages. The encapsulated commands and responses may be transmitted between various devices of an industrial network, including a controller and a gateway device, such as a multiplexer, of the industrial network. Encapsulating the commands and responses may provide a tunneling mechanism allowing a controller complete access to the data of the field devices in communication with the gateway device.

### CROSS REFERENCE TO RELATED APPLICATIONS

This application is related by subject matter to the following applications: PCT application number ______ (also identified by attorney docket number 500402.00594); PCT application number ______ (also identified by attorney docket number 500402.00595); and PCT application number ______ (also identified by attorney docket number 500402.00597). All of the above-mentioned patent applications are herein incorporated by reference and are being filed concurrently with the present application.

### BACKGROUND

Devices connected to an industrial network, such as a network with devices used in automation control or some other type of process control, may use various protocols to communicate with each other. Using specific communication protocols may allow access to particular data throughout the network, but may also cause other data to be inaccessible to some devices. For example, some widespread communications protocols, such as MODBUS, cannot provide a controller of the industrial network with complete access to the data of some types of field devices. Providing a controller complete access to the data of a field device may allow for increased controller functionality in an industrial network, which can improve automation and process control. Consequently, there is a need to improve the access a controller has to the data of the field devices.

### SUMMARY

Some aspects of the disclosure relate to methods for tunneling or encapsulating various messages using MODBUS protocol.

In some variations, systems and methods described herein may include aspects related to a controller of an industrial network, a gateway device of the industrial network, and one or more field devices of the industrial network.

In some embodiments, the gateway device may be configured to receive, from the controller, one or more requests that encapsulate a command conforming to a protocol for communicating with a field device, such as, for example, a Highway Addressable Remote Transducer (HART) protocol. In some arrangements the one or more requests may conform to an application layer messaging protocol, such as, for example, MODBUS. The gateway device may also extract the command from the one or more requests and transmit the command to the one or more field devices. The gateway device may further receive data responsive to the command from the one or more field devices, encapsulate the data in one or more responses (e.g., MODBUS responses), and transmit the one or more responses to the controller.

Additionally, in some arrangements, the controller may be configured to create a command, such as a HART command that requests an ID number or product code from the one or more field devices. The controller may encapsulate the command in one or more requests and transmit the one or more requests to a gateway device. The controller may further receive one or more responses from the gateway device, extract data from the one or more responses, and subject the data to further processing. For example, in instances where the data includes an ID number or product code of a field device, the controller may verify that the ID number or product code matches an expected value.

The preceding presents a simplified summary in order to provide a basic understanding of some aspects of the disclosure. The summary is not an extensive overview of the disclosure. It is intended neither to identify key or critical elements of the disclosure nor to delineate the scope of the disclosure. The summary merely presents some concepts of the disclosure in a simplified form as a prelude to the description below.

### BRIEF DESCRIPTION OF THE DRAWINGS

The present disclosure is illustrated by way of example and is not limited in the accompanying figures.

FIG. 1 illustrates an example of an industrial network, in accordance with various aspects of the disclosure.

FIG. 2 illustrates an example computing device on which various methods of the disclosure may be implemented, in accordance with various aspects of the disclosure.

FIG. 3 illustrates an example data model for network communications, in accordance with various aspects of the disclosure.

FIG. 4A provides an example method for transmitting encapsulated HART commands using MODBUS, in accordance with various aspects of the disclosure.

FIG. 4B provides an example method for processing MODBUS requests and transmitting encapsulated HART responses using MODBUS, in accordance with various aspects of the disclosure.

FIG. 4C provides an example method for receiving encapsulated HART responses using MODBUS, in accordance with various aspects of the disclosure.

FIGS. 5A and 5B illustrate example data formats that may be used for encapsulating HART commands and HART responses using MODBUS, in accordance with various aspects of the disclosure.

FIG. 5C illustrates an example data format that may be used for an exception handling message, in accordance with various aspects of the disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

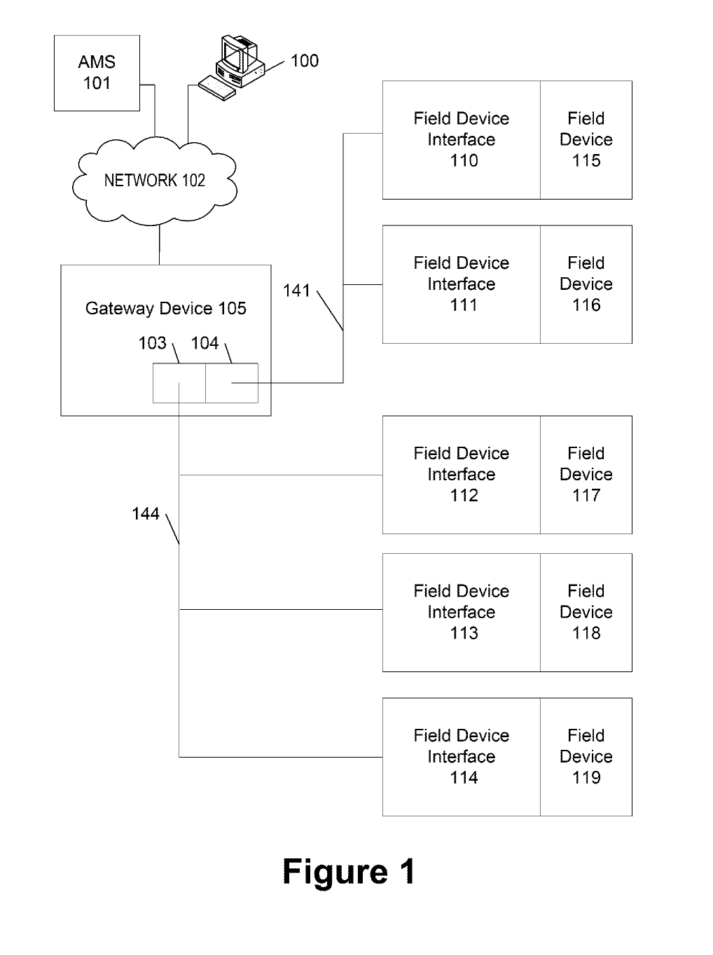

FIG. 1 illustrates an example of an industrial network. Such a network may be used, for example, to control, monitor or regulate various industrial processes such as, for example, an amount of fluid that is allowed into a mixing device using various sensors and actuators. It is to be understood that industrial networks may be made up of a number of other devices, that industrial networks may have different network configurations, and that industrial networks may serve different purposes. The network shown in FIG. 1 is merely an example.

In this example, a controller 100, such as, for example, a programmable logic controller (PLC), personal computer, distributed control system, remote terminal unit, or human-machine interface (HMI) device, may be connected to a gateway device 105, such as, for example, a multiplexer or switch, via a network 102.

Gateway device 105 may also be connected to one or more field devices, such as field devices 115-119. Gateway device 105 may include one or more modems, such as modem 103 and modem 104 (e.g., a frequency shift keying modem), to facilitate communication to and from the field devices 115-119. Gateway device 105 may also include one or more universal asynchronous receiver/transmitters (UART), such as, for example, one UART for each modem. Gateway device 105 may also include one or more processors, and memory. In some embodiments, the connections to the field devices (depicted as connection 144 and 141 in FIG. 1) may be wired (e.g., via two-wire connections, four wire connections, twisted pair wires, transmission lines suitable for 4-20 milliamp instruments, Ethernet cables, or other cable type), wireless (e.g., IEEE 802.11b, or the like), or a combination thereof. Network 102 may also include wired connections, wireless connections, or a combination thereof. In some arrangements, connection 144 may be a first current loop and connection 141 may be a second current loop. In some variations, connection 144 and/or connection 141 may be a collection of wires so that each field device has its own wire directly connecting the field device to a modem of the gateway device. In embodiments similar to that illustrated in FIG. 1, controller 100 may transmit and receive data (e.g., messages or requests) to/from gateway device 105. Gateway device 105 may transmit and receive data (e.g., messages or requests) to/from field devices 115-119.

Asset management software (AMS) 101 may be connected to the gateway device 105. The asset management software may run on any computing device. Asset management software is typically used to monitor the status of an industrial network. This often involves repeatedly checking the status of various sensors, valves, or other field devices. Gateway device 105 may help facilitate these checks by retrieving data from field devices automatically on an ongoing basis. By automatically retrieving data from field devices on an ongoing basis (which is sometimes referred to as “scanning”), the gateway device may improve the speed with which it can provide data to the asset management software.

Many industrial processes rely on inputs being processed and converted to outputs in a deterministic fashion. For example, the process controlling the devices of FIG. 1 may rely on the readings detected by a sensor (e.g., field device 115) and causing a valve (e.g., field device 116) to be adjusted within a threshold time (e.g., 250 milliseconds) of the readings under normal operating conditions. This threshold time limit is an example of an application response time (ART). One aspect of achieving an ART limit is using a controller, such as controller 100 that processes inputs, produces outputs based on those inputs within a predetermined amount of time, and transmits the outputs to gateway device 105 for distribution to the appropriate field device(s) of the industrial network.

Field devices 115-119 may include field device interfaces 110-114, to facilitate the connections to the gateway device 105. Field device interfaces 110-114 may each include a communication module. The communication module may depend on the network type. For example, in some network embodiments, the communication module may be a modem, such as an integrated frequency shift keying modem. Field device interfaces 110-114 may also each include a processor, memory, transmitter, receiver, or other suitable electrical circuitry component. A field device's interface (depicted as field device interfaces 110-114) may be integral with or separate from the field device itself. For example, a field device's interface may be a separate module that connects to the field device using, for example, a group of wires.

Field devices 115-119 may be of various types, such as sensors, transmitters, actuators, or any other device that may be used in an industrial network (e.g., a network for controlling or monitoring an industrial process). In some arrangements, field devices 115-119 may be individually addressable and gateway device 105 may store the information needed to send and receive data directly to/from any of the field devices 115-119. In some arrangements, gateway device 105 and field devices 115-119 may communicate with each other using a Highway Addressable Remote Transducer (HART) protocol, provided by the HART Communication Foundation (HCF), or some variant of the HART protocol. Other protocols may be used by the field devices 115-119 to communicate. Accordingly, in some variations, the modems included in the gateway device 105 and field devices 115-119 may be HART modems. In general, the HART protocol may be considered a master-slave protocol (interchangeably referred to as a client-server protocol) where HART data is superimposed on an analog signal (e.g., a 4 to 20 milliamp signal). In some embodiments, the gateway device 105 may be considered the “master” HART device, and each of the field devices 115-119 may be considered the “slave” HART devices. Although five field devices are shown in FIG. 1, an industrial network may contain any number or type of field device(s). The HART protocol may also be considered a protocol for communicating with field devices (e.g., field devices 115-119).

The HART protocol may include different operational modes, such as a point-to-point mode, where digital signals are superimposed on an analog signal. In a point-to-point mode, both the digital signal and the analog signal carry information to/from a HART field device. Another example of an operational mode is the multidrop mode where digital signals are superimposed onto a constant analog signal and only the digital signal carries information to/from a HART field device. In the multidrop mode, the digital signal may comprise a packet (e.g., a HART packet) and the packet may include an address that identifies a particular one of the HART field devices to which the packet is being directed (or from which the packet is being sent). A HART field device may monitor the digital signal until a packet matching its address is identified.

A HART packet may be structured as follows: a preamble field (length of 5-20 bytes) for synchronization and carrier detection; a start byte field (length of 1 byte) that specifies the master number; an address field (length of 1 or 5 bytes) that specifies a device address; a command field (length of 1 byte) that specifies a numerical value for the command to be executed; a number of data bytes field (length of 1 byte) that indicates the size of the data field; a status field (length of 0-2 bytes) for execution and health reply (in some arrangements, a status field may only be included in HART responses); a data field (length of 0-253 bytes) for data associated with the command; and a checksum field (length of 1 byte) for error detection.

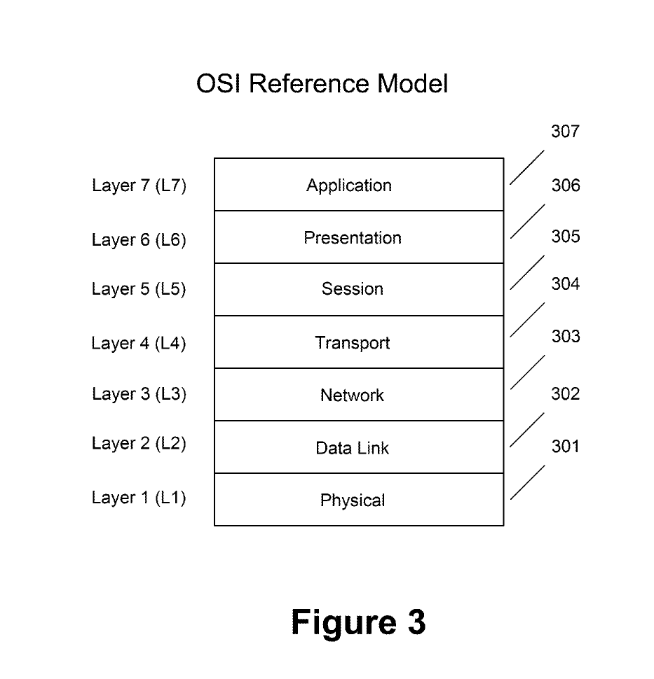

In some arrangements, communication between controller 100 and gateway device 105 may utilize a protocol different from the protocol used between the gateway device 105 and the field devices 115-119. For example, communication between controller 100 and gateway device 105 may utilize a MODBUS protocol, provided by the Modbus Organization, or some variant of a MODBUS protocol. In general, the MODBUS protocol is an application layer messaging protocol that is positioned at level 7 of the Open Systems Interconnection (OSI) Reference Model, which, for example, provides for a layered communication architecture. FIG. 3 illustrates one representation of an OSI Reference Model, which includes physical layer 301, data link layer 302, network layer 303, transport layer 304, session layer 305, presentation layer 306 and application layer 307.

The MODBUS protocol may be considered a request/reply protocol between a master and slave or client and server. Devices using the MODBUS protocol may offer data services specified by function codes. For example, various function codes may be defined by a MODBUS protocol for various read or write commands. A function code is included in a MODBUS protocol data unit (PDU), which may be defined independent of the underlying communication layers. A MODBUS PDU may include a function code (e.g. coded to a length of one byte) that identifies what action to perform and a data field (e.g., of varying length) that may contain additional information used when taking the action defined by the function code. Such additional information may include discrete addresses or register addresses, a quantity of items to be handled, or the count of actual data bytes in the data field. In some instances, the data field may be non-existent.

Additionally, in some variations, a MODBUS PDU (interchangeably referred to as a MODBUS message) may be of various types. For example, a MODBUS PDU may be a request or command (e.g., a request sent from controller 100 to gateway 105), which may otherwise be referred to as a MODBUS request. A MODBUS PDU may be a response to an earlier sent command (e.g., a response sent from the gateway device 105 to the controller 100 that is responsive to an earlier request PDU sent by controller 100), which may otherwise be referred to as a MODBUS response. A MODBUS PDU may also be an error condition, which may otherwise be referred to as a MODBUS exception response. A MODBUS response may include the same function code as a MODBUS request to indicate the command that corresponds to the response. A MODBUS response may include a data field with additional information. A MODBUS exception message may include its own function code that identifies it as an exception response, and a second code to indicate what type of error occurred.

In addition to MODBUS and HART, devices of an industrial network may utilize various types of communication protocols. For example, devices may communicate using DeviceNet, CompNet, ControlNet, Profinet, and the like.

Although FIG. 1 is illustrated with only one controller 100 and one gateway device 105, an industrial network may include several computers similar to controller 100 and/or several gateway devices. If the several computers communicate with one another across a network in order to produce an output, the output may be communicated to one or more of the several gateway devices for transmission to one or more of the field devices. Additional alterations may also be made to the industrial network illustrated in FIG. 1. For example, controller 100 may be modified to include gateway device 105 as one of its components. If gateway device 105 is incorporated into controller 100, controller 100 may still include an Ethernet port for communications with other outside devices, other controllers, and other computing devices.

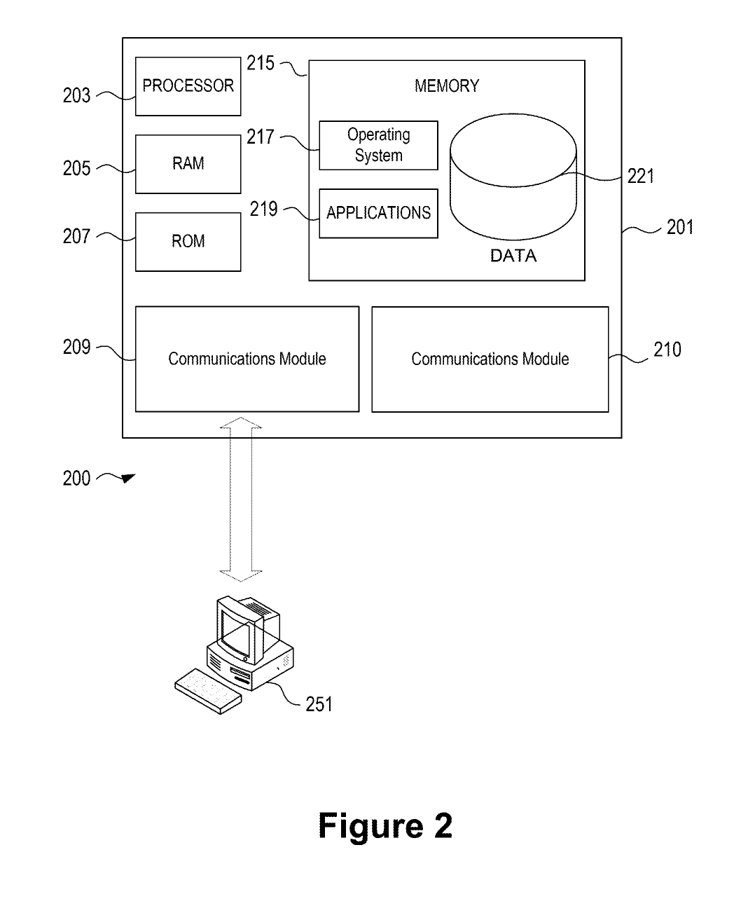

With reference to FIG. 2, the computing system environment 200 may include a computing device 201 wherein various aspects discussed herein may be implemented. Computing device 201 provides an example of general hardware and software elements that may be used to implement any of the various devices discussed herein, such as gateway devices, multiplexers, field devices, field device interfaces, switches, controllers and the like. Computing device 201 may include one or more processors 203, which may execute instructions to perform any of the features described herein. The one or more processors 203 may control overall operation of the computing device 201 and its associated components, including random-access memory (RAM) 205, read-only memory (ROM) 207, one or more communications modules (e.g., communication module 209 and communications module 210), and memory 215. Structures such as FPGAs (field programmable gate arrays) and/or ASICs (application-specific integrated circuits) may also be used.

Computing device 201 may include a variety or combination of computer-readable media, storage media, and/or communication media. Computer-readable media include any available media that can be accessed by computing device 201. By way of example, and not limitation, computer-readable media may comprise a combination of computer storage media and communication media. Storage media include volatile and nonvolatile, removable and non-removable media implemented in any method or technology for storage of information such as computer-readable instructions, object code, data structures, program modules, or other data.

Communication media may embody computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a direct-wired connection (e.g., Ethernet, etc.), and wireless media such as acoustic, RF, infrared and other wireless media.

Communications module 209 may include a microphone, keypad, touch screen, and/or stylus through which a user of computing device 201 may provide input, and may also include one or more of a speaker for providing audio output and a video display device for providing textual, audiovisual and/or graphical output. Communication module 209 may also support a direct-wired and/or wireless connection for communicating with another device.

Software may be stored within memory 215 and/or other storage media to provide instructions to processor(s) 203 for enabling computing device 201 to perform various functions. For example, memory 215 may store software used by the computing device 201, such as an operating system 217, application programs 219, and a database 221. Also, some or all of the computer executable instructions for computing device 201 may be embodied in hardware or firmware. Computer readable instructions may be stored in a ROM, RAM, removable media, such as a Universal Serial Bus (USB) drive, compact disk (CD) or digital versatile disk (DVD), floppy disk drive, or any other desired electronic storage medium. Instructions may also be stored in an attached (or internal) hard drive.

Additionally, one or more application programs 219 used by the computing device 201, according to an illustrative embodiment, may include computer executable instructions for invoking user functionality related to communication including voice input and speech recognition applications (e.g., for transmitting/receiving MODBUS commands, etc.).

Computing device 201 may support a point-to-point connection to a computing device 251 (e.g., a field device within an industrial network, a PLC, controller, etc.). The computing device 251 may be a computing device that includes many or all of the elements described above relative to the computing device 201. While FIG. 2 illustrates communication module 209 as being in communication with computing device 251, communications module 210 may be in communication with a similar computer device.

Although not required, various aspects described herein may be embodied as a method, a data processing system, or as a computer-readable medium storing computer-executable instructions. For example, aspects of the method steps disclosed herein may be executed by processor(s) 203 or instructions stored on computer-readable media may be configured to cause processor(s) 203 to perform steps of a method in accordance with aspects of the disclosure. As another example, one or more aspects of the disclosure may be embodied in computer-usable or readable data and/or executable instructions, such as in one or more program modules, executed by one or more processors or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer-readable instructions may be stored on a computer readable medium, as described above. The functionality of the program modules may be combined or distributed as desired in various illustrative embodiments. In addition, the functionality may be embodied in whole or in part in firmware or hardware equivalents such as integrated circuits, field programmable gate arrays (FPGA), and the like. Particular data structures may be used to more effectively implement one or more aspects of the disclosure, and such data structures are contemplated within the scope of executable instructions and computer-usable data described herein.

The steps that follow in the Figures may be implemented by one or more of the components in FIGS. 1 and 2 and/or other components, including other computing devices.

As discussed above, a gateway device (e.g., gateway device 105), such as a multiplexer in an industrial network, may communicate with another computer (e.g., controller 100), such as a PLC in the industrial network, using the MODBUS protocol, or some other suitable application layer or request/reply protocol. The gateway device may also communicate with the various field devices (e.g., field devices 115-119), such as the sensors, switches and actuators of the industrial network, using the HART protocol.

To allow complete control and/or monitoring of the HART field devices, the MODBUS communication (or application layer communication) between the gateway device and the computer may include encapsulated HART messages (also referred to as tunneling of HART messages over MODBUS). HART messages may be of various types, including HART commands, HART responses and HART error responses. Such encapsulation may allow for all of the HART data of a field device (e.g., data that is located at the gateway device or the field device) to be accessible to the computer. For example, in some variations, a controller and a gateway device may support the exchange of HART process variables over MODBUS (a MODBUS PLC executing a logic program and an HRM V1.0 HART multiplexer is one set of example devices that may be used to support the exchange of HART process variables over MODBUS). The exchange of HART process variables over MODBUS may also be supported by a human-machine interface (HMI) and a gateway device, or a supervisory control and data acquisition (SCADA) system and a gateway device. However, the controller (or other computer supporting the exchange) and the gateway device may not allow for the exchange of any other parameters present in the HART field devices, such as, for example, the exchange of a field device's manufacturer's ID number or product code, version, and tag name. By encapsulating HART messages within MODBUS messages, a gateway device and controller may allow complete read/write access to a HART field device's data, including process, configuration, diagnostic and variable data. Allowing complete access to a HART field device's data may allow for additional functionality to be implemented by a controller, such as, for example, verification that the correct field device is connected prior to using its data, or dynamically tuning parameters (e.g., thresholds, scaling factors, high or low limit values, etc.) depending on the process control.

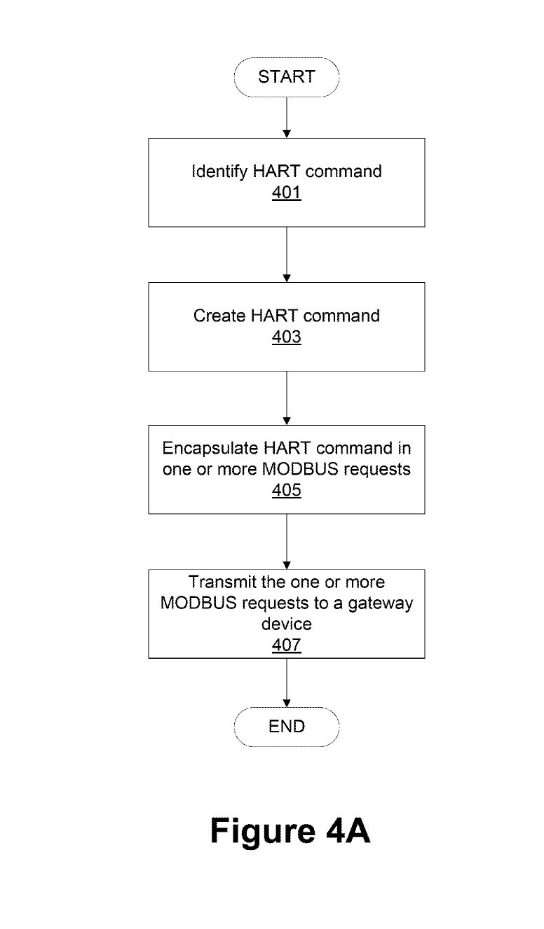

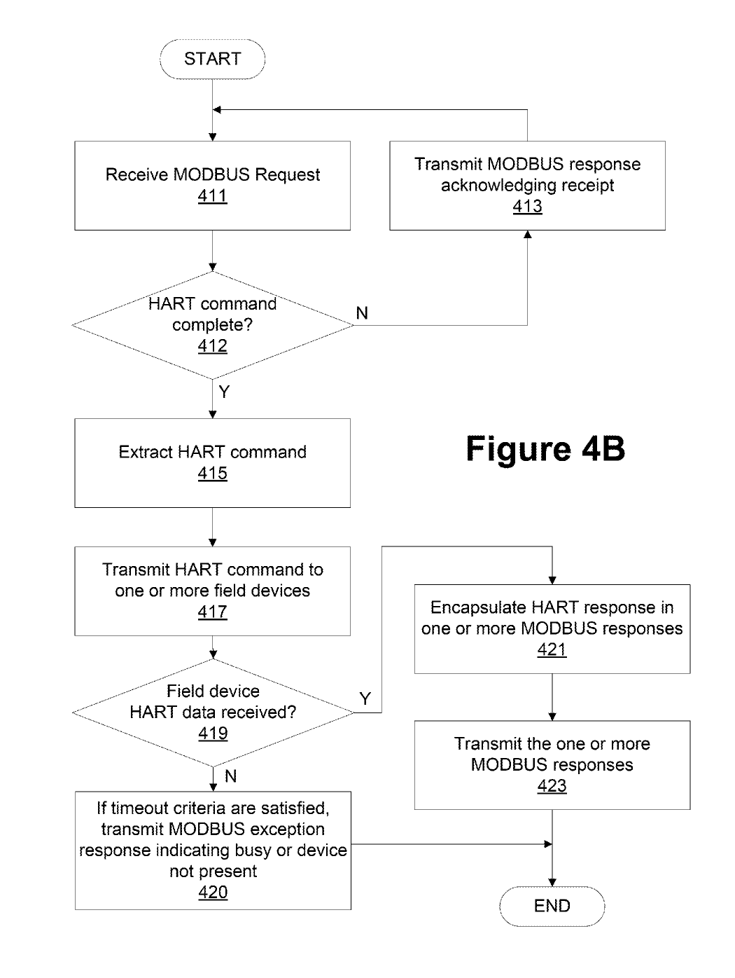

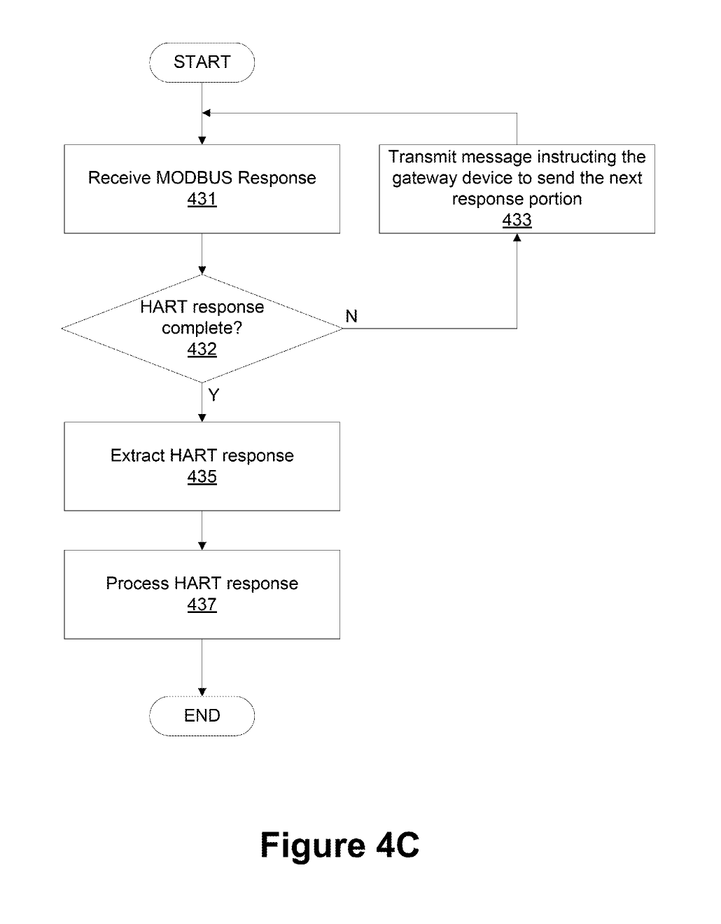

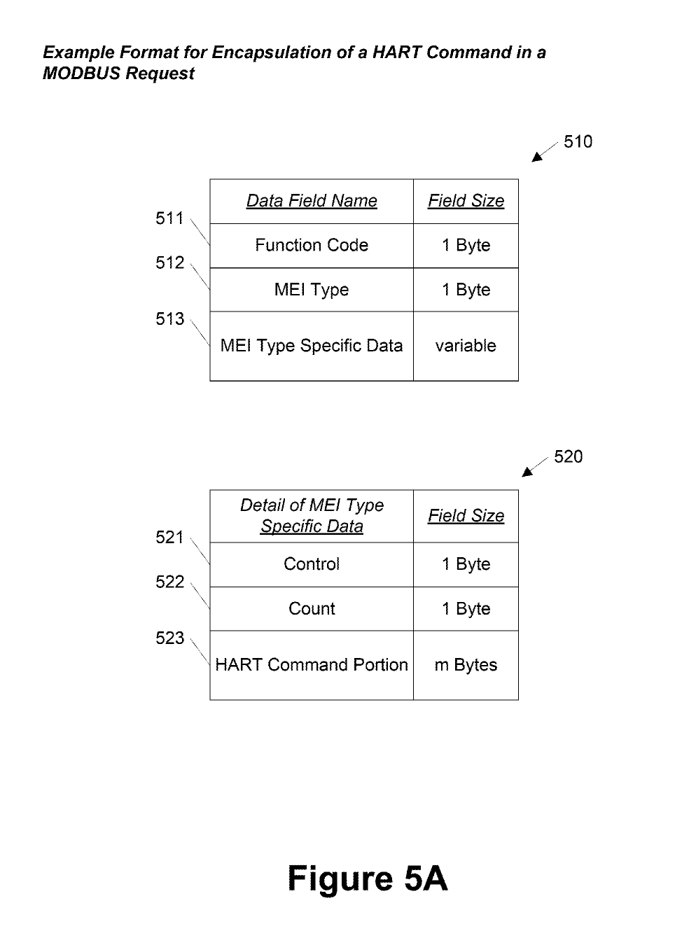

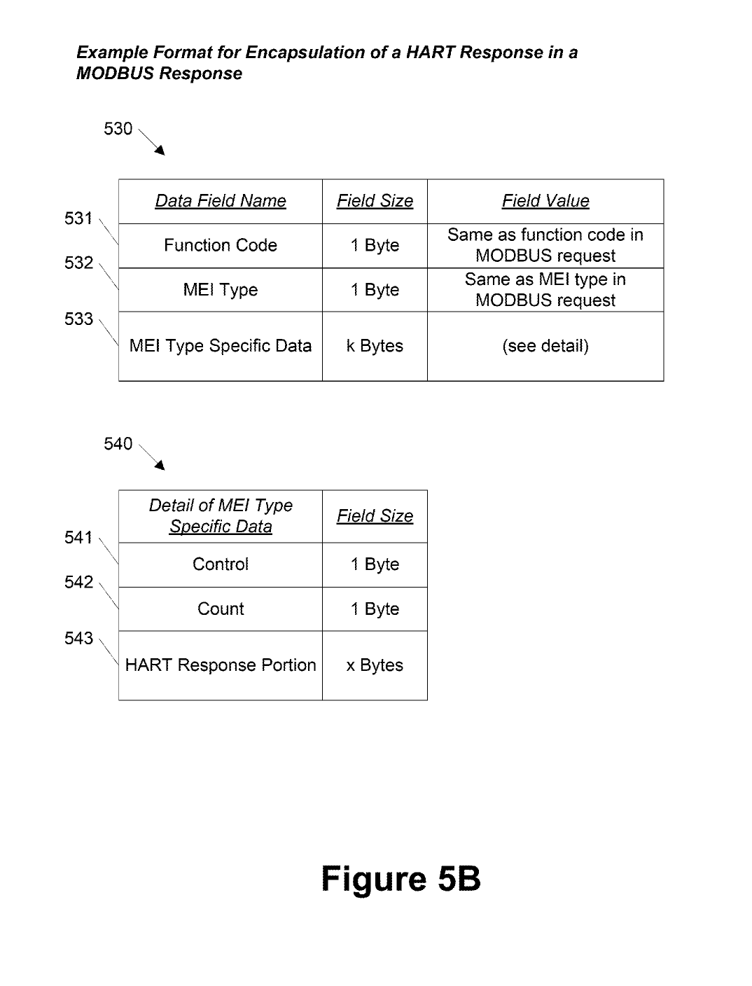

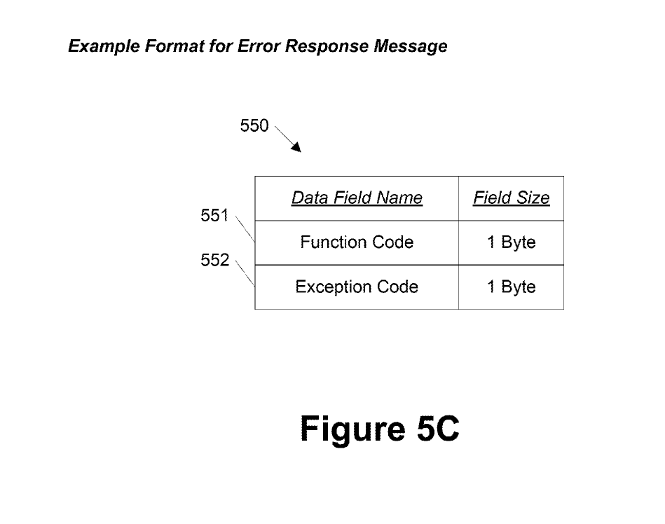

In some arrangements, a controller (e.g., controller 100) may be configured to transmit encapsulated HART commands to a gateway device, such as a multiplexer. FIG. 4A provides an example method for transmitting encapsulated HART messages using MODBUS. In some arrangements, other protocols instead of MODBUS may be used, including another suitable application layer messaging protocol or another request/reply messaging protocol. Additionally, other protocols instead of HART may be used, such as another protocol for communicating with a field device. Details of the example method of FIG. 4A will be discussed in connection with the example data formats of FIG. 5A. Although the example method of FIG. 4A is discussed in terms of MODBUS and HART protocols, similar methods may be performed using any protocol utilized by devices of an industrial network. MODBUS and HART are examples of suitable protocols.

At step 401, a controller may identify a HART command. For example, the controller may be a PLC executing software for controlling an industrial process or automation process. Execution of the software may cause a need for particular HART data from one of the field devices (e.g., identify a read command for particular HART data) or may cause a need for particular HART data values to be written to one of the field devices (e.g., identify a write command to particular HART data). Additionally, input entered by a user of the controller may cause a need to send particular read or write HART commands to a field device. Continuing the above example, the software or user input may cause a need to read or write a field device's manufacturer's ID number or product code, version, tag name, or other variable, and the corresponding read or write HART command may be identified. While the identified HART command may be dependent on which specification of the HART protocol the communication conforms to, in one or more instances, a HART command for reading a field device's manufacturer's ID number or product code may be HART command #0, and, as a second example, a HART command for writing a field device's tag may be HART command #18.

At step 403, the controller may create the HART command. In some embodiments, creating the HART command may include creating a complete data structure for a HART packet. For example, a HART packet that includes the data needed for the HART command identified at step 401 may be created by the controller. The HART packet that is created by the controller may include, for example, a preamble field, a start byte field, an address field, a command field, a number of data bytes field, a data field, and a checksum field. In other arrangements, only some of the data fields of a HART packet may be created by the controller. For example, the controller may create all data fields of the HART packet except for the preamble and/or the checksum field.

At step 405, the controller may encapsulate the HART command within one or more MODBUS requests, or within one or more messages conforming to an application layer messaging protocol or request/reply messaging protocol. Some variants of MODBUS allow for encapsulated transport. For example, in version 1.1b of the MODBUS Application Protocol Specification, function code 43 is one of two encapsulated transports that are available. The controller may encapsulate the HART command in a PDU for function code 43. Request 510 of FIG. 5A provides an example format of a suitable MODBUS request for encapsulating HART commands. As illustrated in FIG. 5A, request 510 may include field 511 for a function code (length of 1 byte), a field 512 for a MODBUS Encapsulated Interface (MEI) type (length of 1 byte), and a field 513 for additional data specific to the MEI type (variable length). In some arrangements, the value of field 511 may be 43 (0x2B in hexadecimal format) to represent function code 43. The value of field 512 may be the numerical code for an MEI type reserved for HART command or HART message encapsulation. For example, in some variations, an MEI type may be reserved within the range of 0-255 for HART command or HART message encapsulation. In some variations, one or more numbers within the 0-255 range may be part of the MODBUS protocol version being used and the number reserved for HART command or HART message encapsulation may be different from those included as part of the protocol version. As one example, MODBUS version 1.1b defines MEI types for numbers 13 and 14. Accordingly, the MEI type for HART command or HART message encapsulation may be selected from the range of 0-12 or 15-255. The MEI type may identify to a receiving device that the MODBUS request includes an encapsulated HART command or HART message. The values of field 513 may include the HART command, or at least a portion of the HART command.

A detailed example format for field 513 when encapsulating a HART command is shown at detail 520. As illustrated by detail 520, field 513 may include a control field 521 (length of 1 byte), a count field 522 (length of 1 byte), and HART command portion field 522 (length of m bytes).

The control field 521 may be used to indicate whether a complete HART message is encapsulated by the MODBUS request, or whether the HART message is divided between multiple MODBUS requests. For example, a HART command (and the below discussed HART response) may be up to 255 bytes in length and may be divided between two or more MODBUS requests. In some embodiments, control field 521 may indicate which portion of the HART command is included in the MODBUS request. For example, in some variations, the first two bits of the control field may indicate that the complete HART command is encapsulated by this MODBUS request (e.g., via a value of 00 binary), that the first part of the HART command is encapsulated by this MODBUS request (e.g., via a value of 01 binary), or that the second part of the HART command is encapsulated by this MODBUS request (e.g., a value of 10 binary). The remaining bits of the control field may be reserved for future use, and any unexpected value of the control field may be an illegal value (e.g., when the first two bits have a value of 11 binary). Of course, other bits of the control field could be used instead of the first two bits.

The count field 522 may include a value indicating the number of bytes in the HART command portion field 523. In some instances, the number of bytes in the HART command portion field 523 may be equal to the total number of bytes in the HART command (e.g., when the entire HART command can be encapsulated in a single MODBUS request), or may be a value different from the size of the HART command (e.g., when the HART command is divided between two or more MODBUS requests).

HART command portion 523 may include the HART command or a portion of the HART command. In some instances, particular data fields of the HART command may not be included in HART command portion, such as, the preamble and/or checksum fields of a HART command.

In some arrangements where the HART command is divided between more than two MODBUS requests, additional data may be included in the MODBUS request, such as a sequence count field (not shown) to indicate what order the portions should be placed into the reassemble the HART command.

At step 407, the controller may transmit the one or more MODBUS requests to a gateway device. In instances where the HART command requires multiple MODBUS requests, the controller may implement a form of synchronization or handshaking to ensure the multiple MODBUS requests are received by the gateway device. For example, the controller may first send a MODBUS request that includes the first part of the HART command (e.g., with the first two bits of the control field set to a value of 01). The controller may wait for a MODBUS response that instructs the controller to send the next portion of the HART command (or acknowledges receipt of the first portion). While further details of the MODBUS response will be discussed below, the received MODBUS response may include a control field with its value set to zero and a control field set to zero. In response to receiving this MODBUS response, the controller may proceed to transmit the MODBUS request that includes the second part of the HART command (e.g., with the first two bits of the control field set to a value of 10). If the MODBUS response is not received after, for example, a time out condition, the controller may resend the first MODBUS request.

In response to receiving a MODBUS request that encapsulates a HART command, a gateway device may, for example, extract the HART command from the MODBUS request, execute the command and transmit one of various response types to the controller. FIG. 4B provides an example method for processing MODBUS requests and transmitting encapsulated HART responses using MODBUS. In some arrangements, other protocols instead of MODBUS may be used, including another suitable application layer protocol or request/reply protocol. Additionally, other protocols instead of HART may be used, such as another protocol for communicating with a field device. Details of the example method of FIG. 4B will be discussed in connection with the example data formats of FIG. 5B. Although the example method of FIG. 4A is discussed in terms of MODBUS and HART protocols, similar methods may be performed using any protocol utilized by devices of an industrial network. MODBUS and HART are examples of suitable protocols.

At step 411, the gateway device may receive a MODBUS request from a controller (e.g., a MODBUS request transmitted at step 407 of FIG. 4A). Receiving the MODBUS request may include identifying the request as a request that encapsulates a HART command, such as by examining the MEI type of the MODBUS request to determine that it matches the value for the MEI type reserved for HART commands or HART messages.

At step 412, the gateway device may determine whether the HART command encapsulated by the MODBUS request is complete. This may include examining the control field to determine whether its value indicates that the MODBUS request encapsulates a complete HART message (e.g., via a value of 00 at the first two bits of the control field) or that the HART message is divided between multiple MODBUS requests (e.g., via a value of 01 or 10 at the first two bits of the control field). If the control field indicates that the HART message is divided between multiple MODBUS requests, the gateway device may determine whether the other portion(s) of the HART command have already been received by the gateway device. If the HART command is complete (e.g., the MODBUS request encapsulates the entire HART command, or all portions of the HART command have been received), the method may proceed to step 415. However, if the HART command is not complete (e.g., at least one portion of the HART command has not been received), the method may proceed to step 413.

At step 413, the gateway device may transmit a MODBUS response that acknowledges receipt of the MODBUS request. A MODBUS response that acknowledges receipt of the MODBUS request may include a control field with its value set to zero and a count field set to zero. The method may then proceed to wait for receipt of the next portion of the HART command from the controller.

At step 415, the gateway device may extract the HART command from the MODBUS request(s). In instances where the HART command is divided between multiple MODBUS requests, the gateway device may reassemble the HART command from the portions extracted from each MODBUS request. Additionally, the gateway device may add fields to the extracted data. For example, in variations where a MODBUS request never includes a preamble and/or a checksum, the gateway device may add the preamble and/or checksum to the extracted HART command.

At step 417, the gateway device may transmit the HART command to one or more field devices. After transmission of the HART command, the gateway device may proceed to wait for the one or more field devices to respond to the HART command.

In some variations, the time in which it takes for a field device to process and respond to a HART command can exceed time-out values of MODBUS and HART communication. For example, the controller may exceed a time-out condition while the gateway device remains waiting for the response from the field device(s). A busy response may be transmitted by the gateway device when such conditions are likely to happen. Some embodiments may accomplish the busy response via steps 419 and 420 of FIG. 4B.

At step 419, the gateway device may determine (e.g., periodically or upon expiration of a timer) whether the HART data responsive to the HART command has been received from the one or more field devices. If the HART data has been received, the method may proceed to step 421. However, if the HART data has not been received, the method may proceed to step 420.

At step 420, the gateway device may determine if particular timeout criteria are satisfied. If the criteria are satisfied, the gateway device may encapsulate and transmit a MODBUS exception response that indicates a busy exception (e.g., a field device is busy) or that indicates a device is not present (e.g., a field device is not present or working properly). In some embodiments, the busy exception may be sent in the form of a MODBUS response (as opposed to a MODBUS exception response). For example, in some variations, there may be two timeout mechanisms. First, there may be a timer set to ensure the controller does not timeout waiting for a response from the gateway device. If this timer exceeds a threshold value, the busy exception may be sent. Second, there may be a timer set to wait for a response from a field device. If the response is not received from the field device prior to the timer exceeding a threshold value, the exception response indicating the device is not present may be sent. The controller, upon receiving the busy exception, may reset its own timeout mechanism and may retransmit the MODBUS command. When the gateway device receives the retransmitted MODBUS command, it may recognize the command as one that is currently being processed and continue to wait on the response from the field device(s). Upon receiving a MODBUS exception response, the controller may perform various exception handling processes. Details of an example MODBUS exception message are shown in FIG. 5C, which will be discussed below in connection with exception handling.

At step 421, the gateway device may encapsulate the HART response in one or more MODBUS responses. In some instances, the HART response may include a manufacturer's ID number or product code of the field device, the tag parameter of the field device, a version of the field device, or other HART parameter, such as a status of a write command. Similar to the controller's encapsulation of a HART command, the gateway device may encapsulate the HART response in a PDU for function code 43. Response 530 of FIG. 5B provides an example format of a suitable MODBUS response for encapsulating HART responses. The values of response 530 may depend on the values of the MODBUS request received by the gateway device. As illustrated in FIG. 5B, response 530 may include field 531 for a function code (length of 1 byte), a field 532 for an MEI type (length of 1 byte), and a field 533 for additional data specific to the MEI type (variable length). The values of field 531 and 532 may be the same as the values of the MODBUS request received by the gateway device. In other embodiments, however, MODBUS responses may be provided with their own reserved MEI type and field 532 may include the value of the MEI type reserved for MODBUS responses (e.g., an MEI type different from the type for MODBUS requests, but within the range of 0-255). The values of field 533 may include the HART response, or at least a portion of the HART response. Similar to MODBUS requests, a HART response may be divided between two or more MODBUS responses.

A detailed example format for field 533 when encapsulating a HART response is shown at detail 540. As illustrated by detail 540, field 533 may include a control field 541 (length of 1 byte), a count field 542 (length of 1 byte), and HART response portion field 542 (length of x bytes). The control field 541 and the count field 542 may be the same or similar to the control and count fields discussed above with respect to MODBUS requests (e.g., the value of the first two bits of the control field may be selected from 00, 01, and 10 binary to indicate whether the complete HART response is encapsulated in the MODBUS response or whether the HART response is divided between multiple MODBUS responses).

HART response portion 543 may include the HART response or a portion of the HART response. In some instances, particular data fields of the HART response may not be included in HART response portion, such as, the preamble and/or checksum fields of a HART response.

In some arrangements where the HART response is divided between more than two MODBUS responses, additional data may be included in the MODBUS response, such as a sequence count field (not shown) to indicate what order the portions should be placed into the reassemble the HART response.

At step 423, the gateway device may transmit the one or more MODBUS responses to the controller. In instances where the HART response requires multiple MODBUS responses, the gateway device may implement a form of synchronization or handshaking to ensure the multiple MODBUS responses are received by the controller. For example, the gateway device may first send a MODBUS response that includes the first part of the HART response. The gateway device may wait for a MODBUS request that acknowledges receipt of the first portion (or a request that instructs the gateway device to send the next portion). Upon receipt from the controller, the gateway device may proceed to send the next portion of the MODBUS response.

Some steps of FIG. 4B may be optional or not performed in some variations. For example, certain HART commands may be a request for HART data that is stored at the gateway device. In such instances, there may be no need to forward the HART command to a field device and, instead, the data may be accessed after step 415 and then the method may proceed directly to step 421, where the accessed HART data may be encapsulated.

In some instances, the controller may be waiting to receive encapsulated HART data that is responsive to a HART command it previously sent. FIG. 4C provides an example method for receiving encapsulated HART responses using MODBUS. In some arrangements, other protocols instead of MODBUS may be used, including another suitable application layer messaging protocol or request/reply messaging protocol. Additionally, other protocols instead of HART may be used, such as another protocol for communicating with a field device. Although the example method of FIG. 4A is discussed in terms of MODBUS and HART protocols, similar methods may be performed using any protocol utilized by devices of an industrial network. MODBUS and HART are examples of suitable protocols.

At step 431 of FIG. 4C, the controller may receive a MODBUS response from a gateway device (e.g., a MODBUS response transmitted at step 423 of FIG. 4B). Receiving the MODBUS response may include identifying the response as one that encapsulates a HART response, such as by examining the MEI type of the MODBUS response to determine that it matches the value for the MEI type reserved for HART commands or HART messages.

At step 432, the controller may determine whether the HART response encapsulated by the MODBUS response is complete. This determination may include an examination of the control field and/or any previously received HART responses. If the HART response is complete, the method of FIG. 4C may proceed to step 435. However, if the HART command is not complete, the method may proceed to step 433. Generally, the determination of step 432 may be similar to that performed at step 412 of FIG. 4B.

At step 433, the controller may transmit a message instructing the gateway device to send the next response portion. In some arrangements, this may be a MODBUS request that acknowledges receipt of the MODBUS response (or asks for the next portion of the HART response). The MODBUS request transmitted at step 433 may include a control field with its value set to zero and a count field set to zero. Alternatively, the controller may retransmit the previous MODBUS request that encapsulates the HART command. The method may then proceed to wait for receipt of the next portion of the HART response from the gateway device.

At step 435, controller may extract the HART response from the MODBUS response(s). In instances where the HART response is divided between multiple MODBUS requests, the gateway device may reassemble the HART response from the portions extracted from each MODBUS response.

At step 437, the controller may process the HART response. For example, the data of the HART response may be displayed for viewing by a user (e.g., display a requested manufacturer's ID number or product code of a field device), or the data may be stored for further processing by software executing on the controller (e.g., verify that the manufacturer's ID number or product code matches an expected value, analyze the status of the response to the write commend to ensure the write command was successful).

Various steps of FIGS. 4B and 4C may cause the gateway device to transmit an exception handling message, referred to herein as a MODBUS exception response. Various conditions may cause the MODBUS exception response to be transmitted. For example, if the count field of a MODBUS request does not match the number of bytes that follow in the HART data payload, a MODBUS exception response may be transmitted. If the reserved bits in the control field of a MODBUS request are not zero (or some other pre-defined value), a MODBUS exception response may be transmitted. If a portion of the control field of a MODBUS request is an illegal value (e.g., the first two bits being 11 binary), a MODBUS exception response may be transmitted. Upon transmitting or receiving a MODBUS exception response, the current (or most recently sent) MODBUS response or MODBUS request may be discarded by the controller or gateway device.

FIG. 5C illustrates an example data format that may be used for an exception handling message. As illustrated, MODBUS exception message 550 may include a function code field 551 (length of 1 byte), and an exception code field 552 (length of 1 byte). In some variations, function code field 551 may include a value such as the numerical code for function code 43+128 (0xAB in hexadecimal), and the exception code field 552 may include a value indicative of the error. Each different error may have a unique code.

Aspects of the disclosure have been described in terms of illustrative embodiments thereof. While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the features of the aforementioned illustrative examples may be utilized alone or in combination or subcombination with elements of the other examples. For example, any of the above described systems and methods or parts thereof may be combined with the other methods and systems or parts thereof described above. For example, one of ordinary skill in the art will appreciate that the steps described above may be performed in other than the recited order, including concurrently, and that one or more steps may be optional in accordance with aspects of the disclosure. It will also be appreciated and understood that modifications may be made without departing from the true spirit and scope of the present disclosure. The description is thus to be regarded as illustrative instead of restrictive on the present disclosure.

What is claimed is:

1. An apparatus comprising:
one or more processors; and
memory storing executable instructions configured to, when executed by the one or more processors, cause the apparatus to:
receive, from a computing device, one or more requests conforming to an application layer messaging protocol, wherein the one or more requests encapsulate a Highway Addressable Remote Transducer (HART) command;
extract the HART command from the one or more requests;
transmit the HART command to one or more field devices;
receive HART data responsive to the HART command from the one or more field devices;
encapsulate the HART data in one or more responses conforming to the application layer messaging protocol; and
transmit the one or more responses to the computing device.

2. The apparatus of claim 1, wherein the HART command requests an ID number or product code of a field device, a tag parameter of a field device, or version of a field device; and
wherein the HART data includes the ID number or product code of a field device, the tag parameter of a field device, or the version of a field device.

3. The apparatus of claim 1, wherein the HART command writes a scaling factor or a limit value to a field device.

4. The apparatus of claim 1, wherein the application layer messaging protocol is a MODBUS protocol.

5. The apparatus of claim 3, wherein the one or more requests include a MODBUS encapsulated interface (MEI) type field with a numerical value of an MEI type reserved for HART command encapsulation.

6. The apparatus of claim 4, wherein the one or more responses include an MEI type field with a numerical value equal to the MEI type field of the one or more requests.

7. The apparatus of claim 1, wherein the one or more requests include a control field that indicates whether the HART command is divided between the one or more requests, a count field, and a HART command portion field that includes at least a portion of the HART command, wherein the count field indicates a length of the HART command portion.

8. The apparatus of claim 1, wherein the memory further stores executable instructions configured to, when executed by the one or more processors, cause the apparatus to:
determine that the HART data has not been received from the one or more field devices; and
transmit, to the computing device, an error response indicating that the one or more field devices are busy.

9. The apparatus of claim 1, wherein the memory further stores executable instructions configured to, when executed by the one or more processors, cause the apparatus to:
determine that the HART command is not complete upon receiving a first request of the one or more requests;
responsive to determining that the HART command is not complete, transmit, to the computing device, a response acknowledging receipt of the first request; and
responsive to transmission of the response acknowledging receipt of the first request, receive, from the computing device, a second request of the one or more requests.

10. A method comprising:
receiving, at a gateway device and from a computing device, one or more requests conforming to an application layer messaging protocol, wherein the one or more requests encapsulate a Highway Addressable Remote Transducer (HART) command;
extracting the HART command from the one or more requests;
transmitting the HART command from the gateway device to one or more field devices;
receiving, at the gateway device, HART data responsive to the HART command from the one or more field devices;
encapsulating the HART data in one or more responses that conform to the application layer messaging protocol; and
transmitting the one or more responses from the gateway device to the computing device.

11. The method of claim 10, wherein the gateway device is a multiplexer of an industrial network, the computing device is a controller of the industrial network.

12. The method of claim 10, wherein the HART command requests an ID number or product code of a field device, a tag parameter of a field device, or version of a field device; and
wherein the HART data includes the ID number or product code of a field device, the tag parameter of a field device, or the version of a field device.

13. The method of claim 10, wherein the application layer messaging protocol is a MODBUS protocol.

14. The method of claim 13, wherein the one or more requests include a MODBUS encapsulated interface (MEI) type field with a numerical value of an MEI type reserved for HART command encapsulation.

15. The method of claim 14, wherein the one or more responses include an MEI type field with a numerical value equal to the MEI type field of the one or more requests.

16. The method of claim 10, wherein the one or more requests include a control field that indicates whether the HART command is divided between the one or more requests, a count field, and a HART command portion field that includes at least a portion of the HART command, wherein the count field indicates a length of the HART command portion.

17. The method of claim 10, further comprising:
determining that the HART data has not been received from the one or more field devices; and
transmitting, from the gateway device and to the computing device, an error response indicating that the one or more field devices are busy.

18. A system comprising:
a controller of an industrial network;
a gateway device of the industrial network; and
one or more field devices of the industrial network;
wherein the gateway device is configured to:
receive, from the controller, one or more messages conforming to an application layer messaging protocol that encapsulate a command conforming to a protocol for communicating with the one or more field devices;
extract the command from the one or more application layer protocol requests;
transmit the command to the one or more field devices;
receive data responsive to the command from the one or more field devices;
encapsulate the data in one or more responses conforming to an application layer messaging protocol; and
transmit the one or more responses to the controller.

19. The system of claim 18, wherein the controller includes a programmable logic controller (PLC), the gateway device includes a multiplexer, the application layer messaging protocol is a MODBUS protocol, and the protocol for communicating with the one or more field devices is a Highway Addressable Remote Transducer (HART) protocol.

20. The system of claim 19, wherein the controller is configured to:
create the command that requests an ID number or product code from the one or more field devices;
encapsulate the command in the one or more requests;
transmit the one or more requests to the gateway device;
receive the one or more responses from the gateway device; and
extract the data from the one or more responses, wherein the data includes the ID number or product code; and
verify that the ID number or product code matches an expected value.
